(19) United States
(12) Patent Application Publication
(10) Pub. No.: US 2025/0280354 A1
(43) Pub. Date: Sep. 4, 2025

(54) ACCESS FILTERING FOR UNAUTHOIRIZED DEVICES BY AN EDGE DEVICE

(71) Applicant: T-Mobile USA, Inc., Bellevue, WA (US)

(72) Inventors: Geoffrey T. Gibson, Rowlett, TX (US); Scott Francis Migaldi, Cary, IL (US)

(21) Appl. No.: 18/591,417

(22) Filed: Feb. 29, 2024

(51) Int. Cl. H04W 48/16; H04W 4/90; H04W 48/08

(52) U.S. Cl. CPC H04W 48/16; H04W 4/90; H04W 48/08

(57) ABSTRACT

Techniques for managing a communication session for an unauthorized user equipment (UE) are described herein. A telecommunications system can implement an edge computing device to determine a communication channel that enables an unauthorized UE to communicate with an emergency service provider and/or receive instructions to receive one or more services. The edge computing device can determine that the UE is not associated with a mobile network operator or is otherwise untraceable, and configure a first communication channel between the UE and emergency service provider or a second communication channel for exchanging data over an access network independent of using a core network of the telecommunications system.

### BACKGROUND

Modern terrestrial telecommunication systems include heterogeneous mixtures of second, third, and fourth generation (2G, 3G, and 4G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. Telecommunications systems may include fifth generation (5G) cellular-wireless access technologies to provide improved bandwidth and decreased response times to a multitude of devices that may be connected to a network.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts an example network environment in which an example device can connect to a telecommunications system that includes an example access management system to implement the techniques described herein.

FIG. 2 depicts an example system architecture for a fifth generation (5G) telecommunication network.

FIG. 3 depicts another example network environment in which an example user equipment can connect to a telecommunication system that includes an example access management system to implement the techniques described herein.

FIG. 4 depicts a messaging flow for establishing a communication session through an example access management system.

FIG. 5 depicts a flowchart of an example process for determining communication channels by an example edge computing device.

FIG. 6 depicts an example system architecture for a user equipment.

### DETAILED DESCRIPTION

This application relates to techniques for determining access for an unauthorized user equipment (UE) to a telecommunications network. The techniques can include an edge device (or system) associated with an access network receiving a request for access to a core network of a telecommunications system from the unauthorized UE, and outputting available communication channels to the unauthorized UE. In some examples, the edge device can identify a first communication channel accessible by the unauthorized UE over a core network to a public service access point (PSAP) for communicating with an emergency service provider. The edge device may also or instead identify a second communication channel accessible by an unauthorized UE over the access network independent of the core network. The second communication channel can provide a variety of information or functionality to enable the unauthorized UE access to additional entities (e.g., the core network, a service, or other entity downstream from the access network).

The techniques described herein can include a computing device (e.g., the edge device or access management system) determining presence of malicious activity associated with the unauthorized UE. For example, the computing device can analyze the unauthorized UE over time (e.g., monitor previous and/or current messages associated with the unauthorized UE, etc.) to determine access to entities of telecommunications system. The computing device can be located near an edge of the telecommunications network such as an access network and prior to the core network. In this way, the computing device can detect malicious activity sooner and before the malicious activity reaches a downstream network entity such as the core network, an Access and Mobility Management Function (AMF), or an IP Multimedia Subsystem (IMS) of the telecommunications system, just to name a few. By implementing the computing device as described herein, fewer network entities are potentially impacted by malicious intent by the unauthorized UE improving security of the telecommunications networks.

In various examples, a UE can be classified as “unauthorized” based on one or more of: not being associated with the serving Mobile Network Operator (MNO) (e.g., accessing a network for the first time, subscriber's identity is not registered, etc.), not being traceable (e.g., a device location cannot be determined), being associated with previous malicious activity, and/or not being identifiable (e.g., an identity of the UE cannot be determined, authorized, validated, and/or verified), among others. In some examples, an unauthorized UE may not have an account with a mobile network operator that authorizes the UE to exchange data with another device over a particular network.

The edge device, or edge computing device, can represent a base station, hardware coupled to the UE (e.g., a modem, a processor, etc.), a relay point, an unlicensed access point, or other entity of an access network. In some examples, the edge device can represent an access point that is not owned and/or operated by the MNO and that is configured to send a call via Wi-Fi or other unlicensed access method. In some examples, the edge device can represent a base station (gNB) or other network entity associated with the telecommunications network. The edge device can manage access for a UE including, in various examples, outputting options that enable the UE to connect to the “unauthorized” portions of the telecommunications network. By controlling access using the edge device as described herein, network capacity can be improved by sending fewer messages to downstream entities (e.g., a core network) which also prevents potential malicious activity from reaching such downstream entities.

Generally, the edge device can represent functionality to identify, generate, or otherwise determine various communication channels that enable an unauthorized UE access to different network entities. In various examples, the unauthorized UE can receive a communication channel from the edge device for communication with an emergency service provider and/or for presenting data usable to cause the UE to connect to the core network.

The access techniques described herein can be used to control which network entities are accessed by an unauthorized UE. By way of example and not limitation, the edge device can determine metadata associated with the UE based at least in part on historical data associated with the UE, message data associated with a current message from the UE, and so on. The metadata may describe a) previous activity associated with the UE (e.g., accessed entities, attempted accessed entities, etc.) b) predicted activity associated with the UE (e.g., a likelihood for the UE to be associated with malicious activity, predicted products or services for the UE, etc.), just to name a few. In some examples, the edge device can determine presentation data for output by the UE to enable the UE to exchange data over the core network.

In some examples, the edge device can implement a model to monitor activity of an unauthorized UE over time to predict whether a current message from the unauthorized UE is associated with malicious activity. A UE associated with determined malicious activity can be prevented from accessing a network or device downstream from the edge computing device of the access network. In some examples, the edge device can detect whether one or more of the unauthorized UEs is associated with a denial of service attack (or other attack type) that may impact operation of a network entity (and subsequent functionality for authorized UEs).

The access techniques can be used to enable emergency communications over a telecommunications network for UEs that are not identifiable, traceable, or otherwise associated with the telecommunications network (e.g., not contracted to exchange data over one or more network elements). In some examples, the edge device can send instructions to the UE to cause the UE to use a particular communication channel (e.g., a network slice) to make emergency calls. In various examples, the edge device can receive a message from an unauthorized UE requesting to exchange data with a PSAP and determine the communication channel for exchanging the data.

In various examples, the edge device may represent firmware, hardware and/or software that generates, assigns, selects, or otherwise determines communication channel(s) available for use by a UE. The communication channel(s) can represent (or be associated with) a radio frequency (RF) channel, an optical channel, and/or a relay channel, just to name a few. For example, the relay channel can represent a mobile hotspot, or other network in which a first device relays signals and/or exchanges data with a second device using a tethering technique. A network policy associated with a mobile network operator (MNO) can, for example, determine which types of data (if any) can be transmitted using a particular communication channel (e.g., the relay channel). In various examples, an unauthorized UE can send a message requesting a communication session with another device, the Internet, etc. Based on receiving the message, the edge device can transmit communication channel information to the unauthorized UE independent of the unauthorized UE and/or the edge device exchanging data over a core network. The communication channel information may, for instance, include one or more communication channels for connecting to various entities, as further described herein. For example, different communication channels can be associated with different levels of security to cause an unauthorized device to receive different levels of access (or no access) based on the type of communication channel used. In various examples, a first communication channel may provide an unauthorized device access to the PSAP and a second communication channel may provide the authorized device access to pre-determined content or services, among others. In some examples, a communication channel can enable the unauthorized device to receive a communication channel having a limited service state that does not require a verified subscription to operate on the telecommunications network.

In various examples, the UE may be configured with instructions to implement the techniques described herein. For example, the UE can be configured with the instructions to cause the UE to use a particular communication channel for transmitting a first message to an emergency service provider or a second message to a particular server, base station, or network (e.g., a core network). For example, the first message can represent an initial request for emergency services and the UE can access a communication channel as described herein.

In some examples, the edge device can identify a device identifier (e.g., a P-Access-Network-Information (PANI), an International Mobile Equipment Identity (IMEI), Permanent Equipment Identifier (PEI), or other device identifier, associated with the UE usable for determining an authentication status for the UE. For example, the edge device can use the device identifier to verify whether the UE is registered with a mobile network operator to receive one or more services over a core network.

The access techniques described herein can improve a computing device and/or network in a variety of ways. Quality of service, network bandwidth, can be improved by managing access by an edge device free of requiring a core network to exchange data with an unauthorized UE. For instance, messages from an unauthorized UE can be prevented from reaching the core network thereby improving security (e.g., potential malicious activity by the unauthorized UEs) and/or be assigned a communication channel that protects the network by defining one or more communication channels for communicating, containing, or otherwise processing potentially malicious messages. The access techniques may also improve the telecommunications use of available network entities, processing resources, memory resources, and the like.

In various example, the techniques enable fewer messages to be transmitted over a network (e.g., the core network) by providing data to the UE using one or more access networks. By exchanging fewer messages to establish a communication session, additional bandwidth is available on the core network (e.g., for authorized or unauthorized emergency calls). Further, using the techniques described herein can improve transmission of message data from a UE using a telecommunications network by reducing latency otherwise caused by unauthorized UEs accessing an AMF, IMS, core network, or other entity downstream from the edge device. Further description of the access techniques by the edge device can be found throughout this disclosure including in the figures below.

In addition, the techniques described herein can improve security of a telecommunications network by detecting malicious activity associated with an unauthorized UE that can affect operation of network elements as the unauthorized UE accesses an access network. The techniques may also include taking an action to prevent access to a core network, base station, or the like, based on the indication of malicious activity (e.g., changing a network setting, validating access to entities, etc.)

Though some examples are described in relation to an edge device, in various examples one or more computing devices, networks, or other entities may perform or otherwise be associated with the techniques described herein.

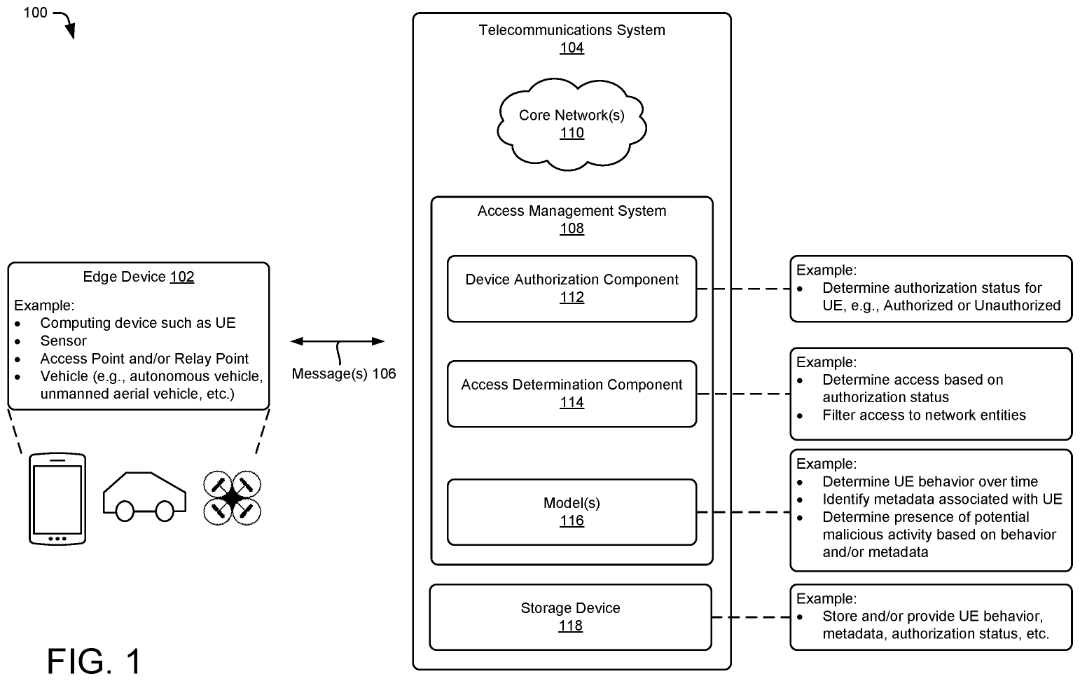

FIG. 1 depicts an example network environment 100 in which an example user equipment (UE) can connect to a telecommunications system that includes an example access management system to implement the techniques described herein. For example, an edge device 102 (e.g., an unauthorized UE) can initiate access a telecommunications system 104 by sending a message 106 to an access management system 108 configured to determine one or more communication channels for the edge device 102. In various examples, the edge device 102 can receive the communication channel(s) from the access management system 108 independent of the edge device 102 exchanging data with one or more core networks 110 (may also be referred to as the core network 110 or the core network(s) 110).

The edge device 102 may represent any device that can wirelessly connect to the telecommunication network, and in some examples may include a mobile phone such as a smart phone or other cellular phone, a personal digital assistant (PDA), a personal computer (PC) such as a laptop, desktop, or workstation, a media player, a tablet, a gaming device, a smart watch, a hotspot, a Machine to Machine device (M2M), a vehicle (e.g., an autonomous vehicle, an unmanned aerial vehicle, airplane, boat, etc.), an Internet of Things (IoT) device, or any other type of computing or communication device.

The message 106 from the edge device 102 can indicate a request for a communication session and may, in some examples, be received via an access network prior to the message 106 reaching the core network 110. In some examples, the message 106 can represent a response (e.g., the communication channels available to the edge device 102) from the access management system 108 to the edge device 102. The core network 110 can represent a 5G network in various examples, though other core network types may also be used (e.g., past or future generation networks such as a sixth generation (6G) network).

The access management system 108 may represent firmware, hardware and/or software that generates, assigns, selects, or otherwise determines a communication channel(s) available to the edge device 102. The access management system 108 may, in some examples, represent an edge device operating in an access network located at an edge of the telecommunications system 104.

In various examples, an unauthorized UE can send a message 106 requesting a communication session with another device, the Internet, a service, etc. Based on receiving the message 106, the access management system 108 can transmit communication channel information to the unauthorized UE independent of the unauthorized UE exchanging data over the core network 110. The communication channel information may, for instance, include one or more communication channels for connecting to various entities (e.g., a base station, a server, a core network, etc.).

In some examples, the access management system 108 can determine, based at least in part on the unauthorized status associated with the UE and an indicator that the message 106 is an emergency message intended for a public service answering point (PSAP), a first communication channel for sending over the core network 110 to the PSAP. For instance, the access management system 108 can determine the first communication channel based at least in part on extracting emergency information (e.g., text, image, etc. associated with an emergency such as a request for an emergency service provider) from the message 106. Additionally, or alternatively, the access management system 108 can determine a second communication channel for sending over the access network and independent of the core network 110. The second communication channel can include information usable by the edge device 102 to receive an authorized status such as presenting options for connecting to a mobile network operator and/or one or more services available to the UE over the core network 110.

FIG. 1 depicts the access management system 108 comprising a device authorization component 112, an access determination component 114, and one or more models 116. FIG. 1 further depicts the telecommunications system 104 (e.g., a 5G system) comprising the access management system 108, the core network(s) 110, and a storage device 118. The access management system 108 (or component thereof) may, for example, exchange data with the storage device 118 (e.g., a memory, a database, etc.) to implement the access techniques described herein. The storage device 118 can represent, for example, a Unified Data Management (UDM) to manage user data and/or an Authentication Server Function (AUSF) to manage authorization for the edge device 102 (e.g., in the 5G system shown). However, in examples when the core network is a different type, such as 4G, the storage device 118 can represent a Home Subscriber Server (HSS). Thus, the storage device 118 can represent various subscription management entities depending upon the example core network used to employ the techniques.

The device authorization component 112 can, for example, represent functionality to validate, authorize, verify or otherwise determine an identity of the edge device 102. For example, the device authorization component 112 can determine an authorization status for the edge device 102 such as an “authorized” status or an “unauthorized” status indicating whether or not the edge device 102 is an authorized to access the core network 110, or other network entity of the telecommunications system 104. In various examples, the device authorization component 112 can analyze the message 106 from the edge device 102 to detect an identifier of the edge device 102 and determine whether the edge device 102 is associated with a mobile network operator (MNO), is traceable, roaming, etc. based on the detected identifier. For example, the device authorization component 112 can detect a device identifier of the edge device 102 based on parsing information in the message 106. The device authorization component 112 can, for example, intercept the message 120 (e.g., a call setup message) and extract or otherwise determine device information associated with the edge device 102. For example, the device authorization component 112 can identify a P-Access-Network-Information (PANI), an International Mobile Equipment Identity (IMEI), Permanent Equipment Identifier (PEI), or other device identifier, associated with the edge device 102 usable to identify the edge device 102.

In various examples, the device authorization component 112 can determine an authorized status or an unauthorized status based on comparing the device identifier to a list, table, or other data indicative of allowable devices. In some examples, the device information can include a Subscription Permanent Identifier (SUPI) (e.g., in a 5G system), an International Mobile Subscriber Identity (IMSI) (e.g., in a 4G system), or the like usable to capture, document, and/or identify a UE. In various examples, the device authorization component 112 can determine that the UE is associated with an IMSI and cannot be authenticated, and the IMSI may be stored as an identifier of the UE to identify the UE (e.g., in a subsequent message to receive emergency services).

As mentioned, the unauthorized status may be determined based at least in part on determining that the UE is not associated with a particular mobile network operator. In some examples, the unauthorized status can indicate that the edge device 102 is not authorized to access a base station, an Access and Mobility Management Function (AMF), or an IP Multimedia Subsystem (IMS) of the telecommunications system 104.

In some examples, the edge device 102 may be determined to have an unauthorized status based on the device authorization component 112 determining whether the edge device 102 is roaming (e.g., a device operating outside an area served by a telecommunication service provider with which the device is registered), unable to receive a call, lacking a service contract with the telecommunications system 104, or is otherwise unauthorized to exchange data over the core network 110.

In some examples, the device authorization component 112 can determine the authorization status based on receiving data from the storage device 118 indicating a current or previous authorization status of the edge device 102. In some examples, the storage device 118 can provide information specific for each edge device 102 usable to recommend a service, product, or network entity for the edge device 102 to access (e.g., recommend a service based on previous network activity by the edge device 102).

The access determination component 114 can represent functionality to determine network entities accessible to the edge device 102 based at least in part on the authorization status output by the device authorization component 112. The access determination component 114 can “filter” data intended downstream from the access management system 108 by providing communication channel information usable by the edge device 102 for accessing different network entities.

By way of example and not limitation, the edge device 102 can send and/or receive one or more messages 106 to exchange data with an emergency service provide via the core network 110. For instance, the edge device 102 can transmit the message 106 (e.g., voice, text, and/or video) that includes a connection request to the emergency service provider. The access determination component 114 can detect the request to the emergency service provider (e.g., by parsing the message 106) and identify a communication channel (e.g., a user plane and/or control plane message, a network slice, or other channel type.) for use by the edge device 102 to enable data to exchange between the edge device 102 and the emergency service provider. The access determination component 114 may also identify an additional communication channel for sending to the edge device 102 (as another message 106) that causes the edge device 102 to output available services (e.g., instead of the edge device 102 being unable to place a call other than to the emergency service provider), etc. but also limits the edge device 102 to accessing certain downstream entities of the telecommunications system 104.

In some examples, the access determination component 114 can determine metadata associated with the edge device 102 based at least in part on message data associated with the one or more messages 106 and/or historical data associated with previous network activity by the edge device 102. In various examples, the access determination component 114 can output metadata describing particular activity (e.g., services used or attempts to access, etc.) associated with the UE over a previous time period. Additionally, or alternatively, the access determination component 114 can output metadata representing predicted activity associated with the edge device 102 in the future (e.g., likely endpoints, devices, services, etc. the edge device 102 may initiate at a later time). In various examples, the access determination component 114 can determine a communication channel for the edge device 102 based at least in part on the metadata and transmit the communication channel to the edge device 102 via the access network.

The access determination component 114 can, in some examples, determine presentation data for output by the edge device 102 to enable the UE to exchange data over the core network 110 (e.g., present data for the edge device 102 to become authorized to use the core network 110). The presentation data can be included in a message transmitted by the access determination component 114, for instance.

The one or more models 116 may be representative of machine learned models, non-machine learning models, or a combination thereof. That is, a model may refer to a machine learning model that learns from a training data set to improve accuracy of an output (e.g., a prediction). Additionally or alternatively, a model may represent logic and/or mathematical functions that generate approximations which are usable to make predictions (e.g., a heuristic model, a statistical model, etc.).

In some examples, a first model can be configured to determine malicious activity associated with the edge device 102 over time including before, during, and after an unauthorized UE exchanges data with the access management system 108. For instance, the first model can monitor activity (e.g., one or more data exchanges) to identify UE behavior representing a malicious event. In some examples, the first model can detect malicious activity associated with the edge device 102 that impacts operation of a network element of the telecommunications system 104. The first model can, for instance, determine whether the edge device 102 causes a base station, a server, or other network entity to perform at or near capacity. The network entity can represent, for example, a base station, an antennae, a transceiver, a serving node, or a computing device of the core network 110, just to name a few.

In various examples, a second model can identify and initiate an action to remedy the malicious activity such as preventing the edge device 102 from accessing a particular network entity, etc. By way of example and not limitation, the second model can perform various techniques to detect changes in UE behavior over time indicative of a UE having malicious intent (e.g., to consume bandwidth to prevent other UEs from accessing the network). In some examples, the second model can represent a machine learned model trained to detect anomalous UE behavior (compared to UE behavior labeled as “normal”, for example), and output a classification of malicious activity for a particular time or time period based on the detected UE behavior. Further, the model can, for example, represent a machine learned model trained to determine one or more actions to mitigate the malicious activity (e.g., reduce an impact to operation of the network by removing the UE from the access network).

In various examples, a machine learned model may be trained based at least in part on training data. Training data may include a wide variety of data, such as image data, video data, audio data, network activity data, sensor data, etc., that is associated with a value (e.g., a desired classification, inference, prediction, etc.). Such values may generally be referred to as a “ground truth.” To illustrate, the training data may be used for determining UE behavior over time and, as such, may include behavior associated with historical network activity and that is associated with one or more classifications (e.g., is an incident present, yes or no). In some examples, such a classification may be based on user input (e.g., user input indicating that the image depicts a specific type of incident) and/or may be based on the output of another machine learned model. In some examples, such labeled classifications (or more generally, the labeled output associated with training data) may be referred to as ground truth.

Generally, the storage device 118 can provide functionality including storing metadata, network information, device information (e.g., authorization status, UE behavior, etc.), user information, and the like. In some examples, the storage device 118 can store, determine, and/or provide information associated with the edge device 102 for use by a component. For instance, the device authorization component 112 can receive UE information indicating historical activity by the edge device 102 over a previous time period for determining an authorization status of the UE.

In various examples, output data from a component of the access management system 108 can be stored in the storage device 118 for access at a later time. For example, the storage device 118 can receive activity associated with an access network, a core network, or the like, for storage and make such data available to a component for processing at a later time (e.g., to determine whether UE behavior is “normal” or “anomalous”).

In various examples, the communication channel information can include security information, bandwidth information, and/or latency information for establishing the communication session between the UE and another device or service (e.g., another UE, the PSAP, etc.).

To implement the techniques described herein, in various examples the telecommunications system 104 and/or the access management system 108 can include one or more of: an a proxy call session control function (P-CSCF), an interrogating call session control function (ICSCF), a serving call session control function (SCSCF), a serving gateway (SGW), a packet data network gateway (PGW), a policy and charging rules function (PCRF), and an internet protocol short message gateway (IPSM-GW), a short message service center (SMSC), and an evolved packet data gateway (ePDG), and a Home Subscriber Server (HSS), just to name a few. In addition, the techniques described herein may be implemented using Real-Time Protocol (RTP) and/or Real-Time Control Protocol (RTCP), among others.

In various examples, the telecommunications system 104 (e.g., a 5G system) can represent functionality to provide a communication channel for the edge device 102, and can include one or more radio access networks (RANs), as well as one or more core networks linked to the RANs. For instance, the edge device 102 can represent a UE to wirelessly connect to a base station or other access point of a RAN, and in turn be connected to the core network (e.g., a 5G core network). The RANs and/or core networks can be compatible with one or more radio access technologies, wireless access technologies, protocols, and/or standards. For example, wireless and radio access technologies can include fifth generation (5G) technology, Long Term Evolution (LTE)/LTE Advanced technology, other fourth generation (4G) technology, third generation (3G) technology, High-Speed Data Access (HSDPA)/Evolved High-Speed Packet Access (HSPA+) technology, Universal Mobile Telecommunications System (UMTS) technology, Global System for Mobile Communications (GSM) technology, WiFi technology, and/or any other previous or future generation of radio access technology. In this way, the telecommunications system 104 is compatible to operate with other radio technologies including those of other service providers. Accordingly, the message(s) 106 from the edge device 102 may originate with another service provider (e.g., a third-party) and be processed by the access management system 108 independent of the technolog (ies) or core network associated with the service provider.

While shown separately in FIG. 1, the device authorization component 112, the access determination component 114, and the model(s) 116 (and the functionality thereof) can be included in a single component of the access management system 108 and/or in another computing device (e.g., the edge device 102 or another device associated with the telecommunications system 104). Further, the functionality associated with the access management system 108 can be included as hardware coupled to the edge device 102.

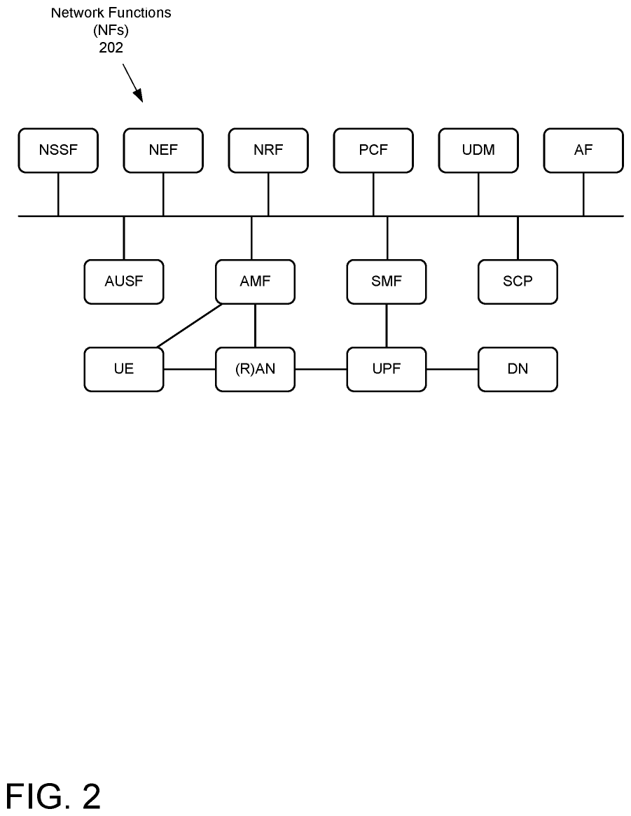

In some examples, the core network 110 can represent a service-based architecture that includes multiple types of network functions that process control plane data and/or user plane data to implement services for the edge device 102. In some examples, the services comprise rich communication services (RCS), a VoNR service, a ViNR service, and the like which may include a text, a data file transfer, an image, a video, or a combination thereof. The network functions of the core network 110 can include an Access and Mobility Management Function (AMF), a Session Management Function (SMF), a User Plane Function (UPF), a Policy Control Function (PCF), and/or other network functions implemented in software and/or hardware, just to name a few. Examples of network functions are also discussed in relation to FIG. 2, and elsewhere.

FIG. 2 depicts an example system architecture for a fifth generation (5G) telecommunication network. In some examples, the 5G telecommunication network can comprise the core network 110 in FIG. 1 that includes a service-based system architecture in which different types of network functions (NFs) 202 operate alone and/or together to implement services. Standards for 5G communications define many types of NFs 202 that can be present in 5G telecommunication networks (e.g., the 5G core network), including but not limited to an Authentication Server Function (AUSF), Access and Mobility Management Function (AMF), Data Network (DN), Unstructured Data Storage Function (UDSF), Network Exposure Function (NEF), Network Repository Function (NRF), Network Slice Selection Function (NSSF), Policy Control Function (PCF), Session Management Function (SMF), Unified Data Management (UDM), Unified Data Repository (UDR), User Plane Function (UPF), Application Function (AF), User Equipment (UE), (Radio) Access Network ((R)AN), 5G-Equipment Identity Register (5G-EIR), Network Data Analytics Function (NWDAF), Charging Function (CHF), Service Communication Proxy (SCP), Security Edge Protection Proxy (SEPP), Non-3GPP InterWorking Function (N3IWF), Trusted Non-3GPP Gateway Function (TNGF), and Wireline Access Gateway Function (W-AGF), many of which are shown in the example system architecture of FIG. 2.

One or more of the NFs 202 of the core network 110 can be implemented as network applications that execute within containers (not shown). The NFs 202 can execute as hardware elements, software elements, and/or combinations of the two within telecommunication network(s), and accordingly many types of the NFs 202 can be implemented as software and/or as virtualized functions that execute on cloud servers or other computing devices. Network applications that can execute within containers can also include any other type of network function, application, entity, module, element, or node.

The core network 110 can, in some examples, determine a connection between an IMS that manages a communication session for the edge device 102, including sessions for short messaging, voice calls, video calls, and/or other types of communications. For example, the edge device 102 and the IMS of the telecommunications system 104 can exchange Session Initiation Protocol (SIP) messages to set up and manage individual communication sessions. In some examples, the IMS of the telecommunications system 104 can generate a network slice to act as a communication channel for a voice communication, video communication, or other communication between the edge device 102 and another computing device of a PSAP, emergency service provider, or the like.

Though some examples in FIG. 1 and elsewhere are described in association with a 5G telecommunication system, the techniques described herein can be used in other telecommunication system types include past generation and/or future generation telecommunication systems.

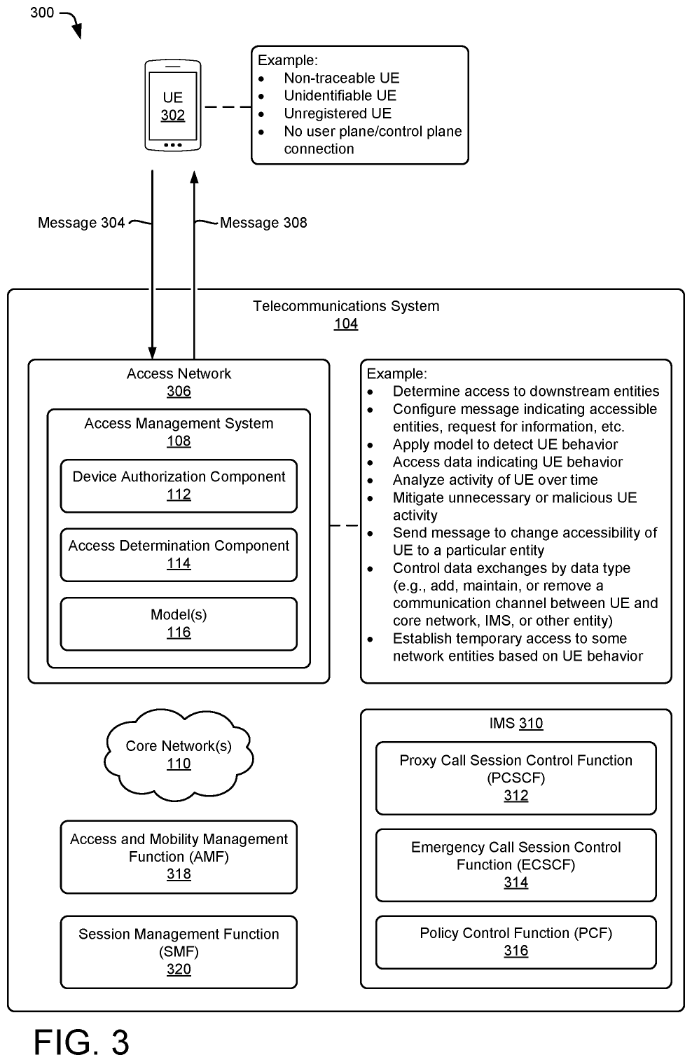

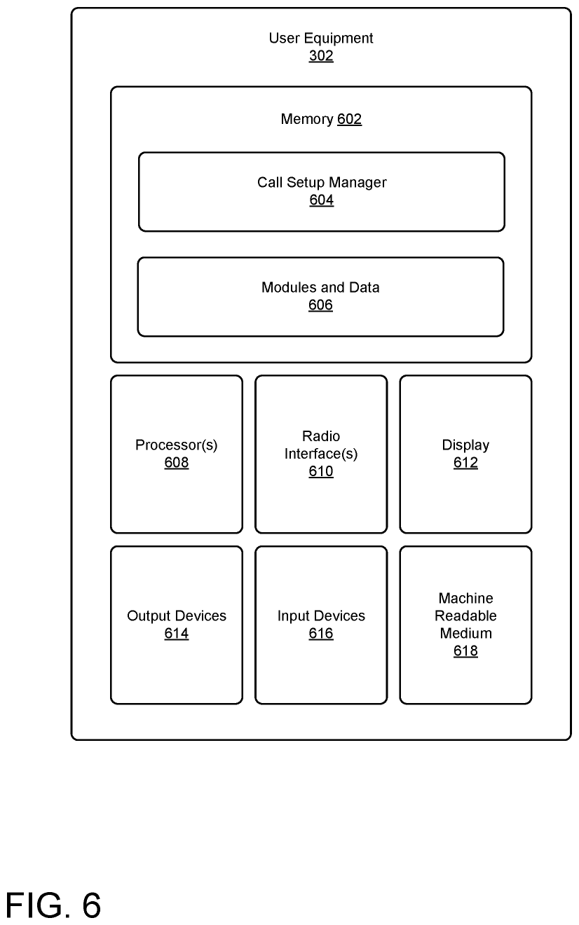

FIG. 3 depicts another example network environment 300 in which an example user equipment can connect to a telecommunication system that includes an example access management system to implement the techniques described herein. For example, a UE 302 (e.g., an unauthorized UE) can initiate access a telecommunications system 104 by sending a message 304 to an access network 306 which includes the access management system 108 of FIG. 1. The access management system 108 can determine one or more communication channel(s) for sending to the UE 302 over the access network 306 as a message 308. An example architecture for the UE 302 is illustrated in greater detail in FIG. 6.

FIG. 3 further depicts the telecommunications system 104 comprising an IMS 310 that further comprises a proxy call session control function (P-CSCF) 312 and an emergency call session control function (E-CSCF) 314, and a Policy Control Function (PCF) 316. The telecommunications system 104 is also shown to comprise an AMF 318 and an SMF 320, though other functions may also or instead be included in various examples.

The UE 302 can, in some examples, include at least the functionality of the edge device 102 of FIG. 1. In various examples, the UE 302 can represent a non-traceable UE, an unidentifiable UE, an unregistered UE, and/or a UE have no user plane/control plane connection. The access management system 108 can represent an edge device (also referred to as an edge computing device) configured to operate using the access network 306 prior to using a core network (e.g., the core network(s) 110). In this way, the access management system 108 can determine access to downstream entities (e.g., a base station, a server, the core network 110, the IMS 310, the AMF 318, etc.) to protect such entities from the UE 302 utilizing or otherwise impacting resources (e.g., network, processor, memory, etc.).

In various examples, the access management system 108 can configure the message 308 to indicate accessible entities to the UE 302 and/or request information from the UE 302 (e.g., an identifier, subscription information, and the like). In various examples, the access management system 108 can also or instead configure a message for sending over the core network 110 such as to the IMS 310, the AMF 318, or the SMF 320.

The model 116 can, for example, detect behavior (e.g., past, current, and/or predicted network activity) associated with the UE 302 and determine which network entities the UE 302 can access based at least in part on the detected UE behavior. More generally, the model 116 can analyze activity by the UE 302 over time to identify potential malicious activity and/or to recommend a communication channel from a set of available communication channels to different entities. A same or different model can determine actions to mitigate an impact of the UE 302 on the network entities whether or not the UE 302 is associated with potential malicious activity.

The access management system 108 can, in various examples, output one or more communication channels to control data exchanges by a target type (e.g., add, maintain, or remove a communication channel between UE and one of: the core network 110, the IMS 310, or other entity).

In some examples, the access management system 108 can establish temporary access (e.g., a period of time less than a maximum time threshold) to a particular network entity (e.g., the E-CSCF 314) to enable an emergency call or to the AMF 318 to establish another call type. The UE 302 may access a network entity based at least in part on the UE behavior determined over time, for example.

The P-CSCF 312 can represent functionality of a proxy server that receives data from the UE 302 at the IMS 310. That is, the P-CSCF 312 can establish and maintain communications between one or more UEs (including UEs of third-parties having unique communication requirements) and various answering points.

In some examples, the E-CSCF 314 can implement functionality to configure an emergency message for sending between a PSAP (not shown) the IMS 310 for delivery to an emergency service provider. For instance, the E-CSCF 314 can retrieve location information (if available) and/or communicate data with the communication channel determined by the access management system 108. Additionally or alternatively, the IMS 310 can determine a protocol usable by the E-CSCF 314 for communicating the emergency message to the PSAP.

In some examples, an invite message can be sent from the P-CSCF 312 to a call session control function (CSCF) server to establish a non-emergency call with another UE.

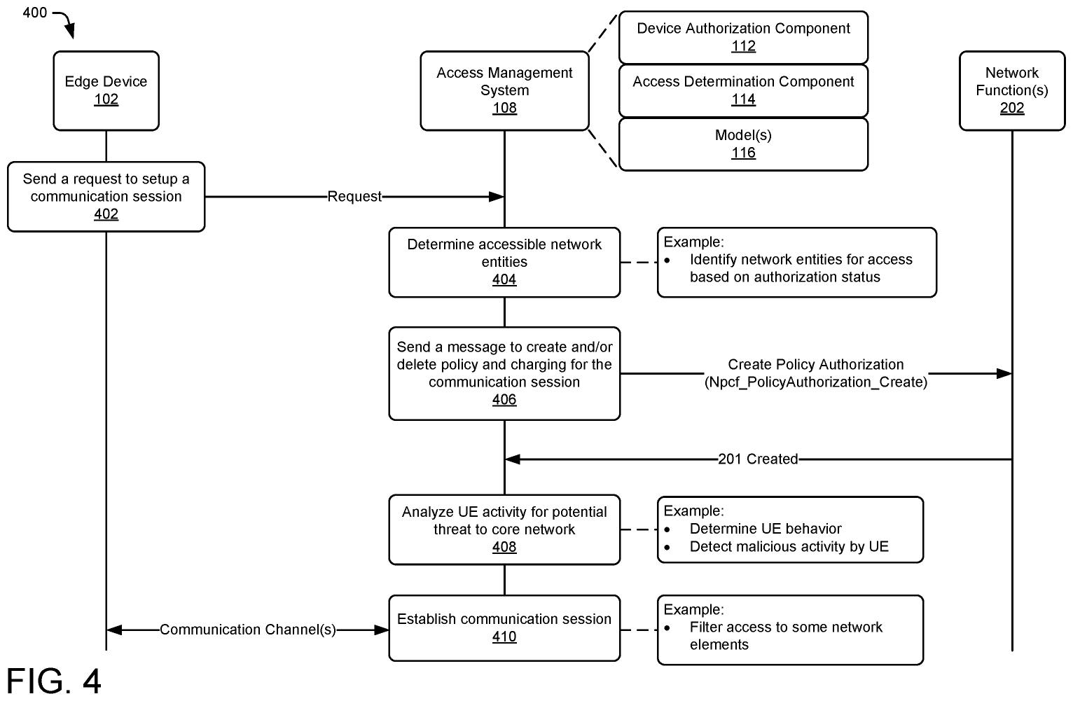

FIG. 4 depicts a messaging flow 400 for establishing a communication session through an example access management system. For example, the edge device 102 of FIG. 1 and/or the UE 302 of FIG. 3 may exchange (e.g., send and/or receive) one or more messages with the access management system 108 (e.g., the device authorization component 112, the network slice component 114, and/or the model(s) 116) to establish a communication session with another UE. In some examples, functionality associated with the device authorization component 112, the access determination component 114, and/or the model(s) 116 can be included in a computing device, or other entity of the telecommunications system 104 that is configured to determine the communication session for the edge device 102. In some examples, the access techniques can be performed by the edge device 102 using hardware, software, and/or firmware coupled to, or associated with, the edge device 102. The access management system 108 can, for example, determine one or more communication channels as describe herein.

In various examples, the edge device 102 may be untraceable, unidentifiable, unlocatable, or otherwise not associated with a mobile network operator (MNO). For example, the edge device 102 can represent a mobile device that is roaming on the access network 306 and the access management system 108 can be employed to direct, assign, or determine one or more communication channels for the edge device 102.

At 402, the UE 302 can send a request to setup a communication session over the access network 306 to the access management system 108 of the telecommunications system 104. For example, the UE 302 can send a call setup message, a test message, or other message usable to connect the UE 302 to an emergency provider, a service, another UE, and so on. The call setup request can include, for example, a message (e.g., the message 106) requesting a communication session with an IMS, an AMF, or other entity of the telecommunications system 104.

At 404, the access management system 108 can determine network entities accessible by the UE 302. For example, the device authorization component 112 can determine authorization status of the UE 302 based on information associated with the request, information stored in a storage device (e.g. the storage device 118). The access management system 108 can, for example, identify network entities accessible by the UE 302 based on the authorization status. The network entities can represent a base station, an antennae, a transceiver, a serving node, a computing device (e.g. a server), just to name a few.

In some examples, the access management system 108 can parse the request to identify whether the request is associated with an emergency event and directed toward an emergency service provider, and determine a communication channel to enable the communication session.

In some examples, the access management system 108 can provide one or more communication channels to the UE 302 at a previous time. One of the communication channels can provide the UE 302 data that enables the UE 302 to establish a temporary service (e.g., authorized to access certain network elements). In such examples, the request can include payment information to cause the device authorization component 112 to update the authorization status from unauthorized to unauthorized to enable the communication session and/or future communication sessions.

At 406, the access management system 108 can send a message to create and/or delete policy and charging for the communication session associated with the UE 302. For example the access determination component 114 can send a message (e.g., a Create Policy Authorization message) to one or more of the network function(s) 202 to authorize a communication session request from the UE. In one non-limiting example, the access determination component 114 can facilitate sending a Npcf_PolicyAuthorization_Create message associated with the Policy Authorization Service to the network function(s) 202. Responsive to receiving the message, the network function(s) 202 can send a 201 created message to the access management system 108.

At 408, the access management system 108 can analyze the UE 302 for potential malicious activity that may cause an impact to the telecommunications system. For instance, the access determination component 114 can determine the behavior over time to detect whether the UE 302 exhibits or has previously exhibited malicious activity. In some examples, the access determination component 114 may employ a machine learned model (e.g. the model 116) that analyzes endpoints accessed or attempted to be accessed by the UE 302. In various examples, the UV behavior may be used by a model or component to recommend a service(s), and provide a communication channel for connecting to the recommended service(s). In various examples, the UE 302 can be analyzed for malicious activity upon the UE 302 initially entering a threshold range of a network entity, for instance, and for a duration that the UE 302 remains in the telecommunications system 104.

The access determination component 114 may, for example, mitigate detected malicious activity by the UE 302 protect the network elements and save resources otherwise used by the UE 302. For example, one or more of the model(s) 116 can monitor the UE 302 over time including before, after, and/or during an exchange of data between the UE 302 and the access management system 108. In various examples, the model(s) 116 can detect a security threat caused by the UE 302 operating, or attempting to operate, in a network (e.g., the access network, the core network, etc.).

At 410, the access management system 108 can establish the communication session for the UE 302 by sending one or more communication channels to the UE 302. The communication channels can be used by the UE 302 to exchange user plane and/or control plane messages as part of the communication session. By way of example and not limitation, a core network can process control plane data and/or user plane data to provide a control plane and/or a user plane between the UE 302 and another device (e.g., another UE, a PSAP after determining that the UE 302 is associated with an emergency call, etc.).

Though the device authorization component 112, the network slice component 114, and/or the model(s) 116) are illustrated in FIG. 4 individually, it is understood that the device authorization component 112, the access determination component 114, and/or the model(s) 116) (or functionality provided therefrom) may be directly coupled to and/or integrated into a single component or computing device (including in some examples the UE). In some examples, functionality associated with the device authorization component 112, the access determination component 114, and/or the model(s) 116) may be directly coupled to and/or integrated into the edge device 102 of FIG. 1 and/or the UE 302 of FIG. 3.

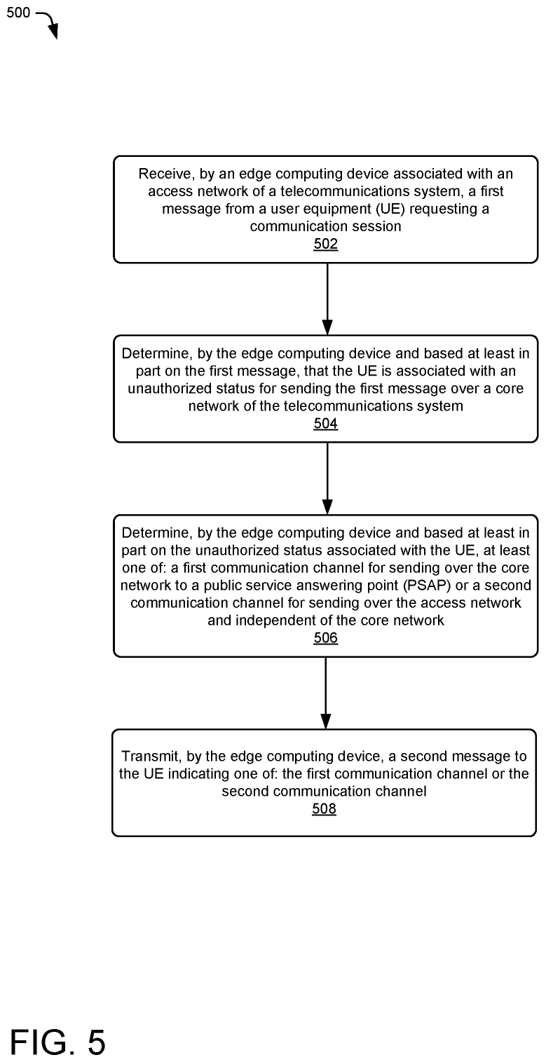

FIG. 5 depicts a flowchart of an example process 500 for determining communication channels by an example edge computing device. Some or all of the process 500 may be performed by one or more components in FIGS. 1-4, as described herein. For example, some or all of process 500 may be performed by the access management system 108 of FIG. 1.

At operation 502, the process may include receiving, by an edge computing device associated with an access network of a telecommunications system, a first message from a user equipment (UE) requesting a communication session. The edge computing device can represent a device using an access network to receive the first message (and prior to the first message using a core network (e.g., the core network(s) 110). In some examples, the operation 502 may include the access management system 108 receiving message data from the edge device 102 indicating that the UE initiated a communication (e.g., requested a communication session with another UE, an emergency service provider, or the like). The access management system 108 may, for instance, receive a message (e.g., the message 106) from the edge device 102 requesting to establish a voice, video, and/or text communication session.

In some examples, the first message can represent a request to attach to a base station or other entity (e.g., an attach request), an identification request associated with an MME (or the like), an identity request, an identity response, a ciphered options request, downlink data, or the like. In various examples, the first message can represent a create session request associated with a gateway of the telecommunications system, uplink data, or a bearer request, among others.

At operation 504, the process may include determining, by the edge computing device and based at least in part on the first message, that the UE is associated with an unauthorized status for sending the first message over a core network of the telecommunications system. For instance, the device authorization component 112 can extract, identify, or otherwise determine an IMEI, or other device identifier, associated with the first message received from the UE. Based on the device identifier, the device authorization component 112 can output a first classification of “authorized” or a second classification as “unauthorized”. In some examples, the device authorization component 112 can determine that the UE is “unauthorized” based on the UE not being registered with a service operator to operate over the core network.

In some examples, the device authorization component 112 can determine that the UE is “unauthorized” based on the message not including a location and/or a contact number for the UE. The UE may also or instead be determined as an unauthorized UE depending upon a device type, capability, or features of the UE. For instance, a UE lacking a modem or an ability to receive data from the access management system 108, a PSAP, and/or another device can be considered unauthorized in various examples. Additionally, or alternatively, a device type such as an IoT or a sensor may lack capabilities, hardware, software, or the like, to receive data from another device but can, nonetheless provide data describing an emergency to the emergency service provider, for example.

In some examples, the access determination component 114 can determine metadata associated with the edge device 102 based at least in part on message data associated with the first message and/or storage data associated with the storage device 118. In various examples, the access determination component 114 can output metadata describing particular activity (e.g., services accessed and/or attempts to access, etc.) associated with the UE over a previous time period. Additionally, or alternatively, the access determination component 114 can output metadata representing predicted activity associated with the edge device 102 in the future (e.g., likely endpoints, devices, services, etc. the edge device 102 may initiate at a later time).

At operation 506, the process may include determining, by the edge computing device and based at least in part on the unauthorized status associated with the UE, at least one of: a first communication channel for sending over the core network to a public service answering point (PSAP) or a second communication channel for sending over the access network and independent of the core network. In some examples, the operation 506 may include the access management system 108 determining the first communication channel for sending data associated with the first message over the core network to the PSAP and/or the second communication channel for sending over the access network to provide a different level of service to the edge device 102 that would otherwise not be available. For instance, the second communication channel can enable an exchange of data between network entities other than the core network to reduce an impact of the unauthorized UE on the core network. In various examples, the first communication channel can enable an emergency call to reach the core network, and eventually the PSAP.

In some examples, the operation 506 may include the access determination component 114 sending a request for information to the storage device 118 for historical application data or other user information, device information, and the like identifying application activity, network activity, etc. by the UE over a previous time period. The data provided by the storage device 118 can be used during operations to determine a communication channel specific for the UE.

In various examples, the access determination component 114 can determine a communication channel for the edge device 102 based at least in part on the metadata as described herein.

At operation 508, the process may include transmitting, by the edge computing device, a second message to the UE indicating one of: the first communication channel or the second communication channel. In some examples, the operation 508 may include the access management system 108 transmitting data indicating the first communication channel and/or the second communication channel to the edge device 102 over the access network to cause the UE to access a network entity associated with a respective communication channel. Transmitting the second message may be performed over the access network and independent of a core network. In some examples, the edge computing device may send a request for data to an AMF or an IMS of the telecommunications system to configure or determine a particular communication channel.

In some examples, the unauthorized status can indicate that the UE is not authorized to access a base station, the AMF, and/or the IMS of the telecommunications system, just to name a few. Operation 508 may include, for instance, transmitting the second message based at least in part on determining that the UE is not authorized to access a network entity downstream from the edge computing device.

In examples when the edge computing device represents hardware coupled to the UE, the transmitting can include sending the communication channel(s) from the hardware to another portion of the UE, such as a call setup component.

FIG. 6 depicts an example system architecture for the UE 302, in accordance with various examples. As shown, a UE 302 can have memory 602 storing a call setup manager 604, and other modules and data 606. A UE 302 can also comprise processor(s) 608, radio interfaces 610, a display 612, output devices 614, input devices 616, and/or a machine readable medium 618.

In various examples, the memory 602 can include system memory, which may be volatile (such as RAM), non-volatile (such as ROM, flash memory, etc.) or some combination of the two. The memory 602 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the UE 302. Any such non-transitory computer-readable media may be part of the UE 302.

The call setup manager 604 can send and/or receive messages comprising a VoNR service, a ViNR service, and/or an RCS service including SIP messages associated with setup and management of a call session via an IMS, an AMF, or the like. The SIP messages can include an SIP INVITE message and/or other SIP messages.

The other modules and data 606 can be utilized by the UE 302 to perform or enable performing any action taken by the UE 302. The modules and data 606 can include a UE platform, operating system, and applications, and data utilized by the platform, operating system, and applications.

In various examples, the processor(s) 608 can be a central processing unit (CPU), a graphics processing unit (GPU), or both CPU and GPU, or any other type of processing unit. Each of the one or more processor(s) 608 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 608 may also be responsible for executing all computer applications stored in the memory 602, which can be associated with common types of volatile (RAM) and/or nonvolatile (ROM) memory.

The radio interfaces 610 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 610 can be compatible with multiple radio access technologies, such as 5G radio access technologies and 4G/LTE radio access technologies. Accordingly, the radio interfaces 610 can allow the UE 302 to connect to a 5G system and/or a 4G system (or other past or future system) as described herein.

The display 612 can be a liquid crystal display or any other type of display commonly used in UEs. For example, display 612 may be a touch-sensitive display screen, and can then also act as an input device or keypad, such as for providing a soft-key keyboard, navigation buttons, or any other type of interactive input. In some examples, the display 612 can represent a wearable device such as a headset for presenting and/or receiving data associated with a user. The output devices 614 can include any sort of output devices known in the art, such as the display 612, speakers, a vibrating mechanism, and/or a tactile feedback mechanism. Output devices 614 can also include ports for one or more peripheral devices, such as headphones, peripheral speakers, and/or a peripheral display. The input devices 616 can include any sort of input devices known in the art. For example, input devices 616 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 618 can store one or more sets of instructions, such as software or firmware, that embodies any one or more of the methodologies or functions described herein. The instructions can also reside, completely or at least partially, within the memory 602, processor(s) 608, and/or radio interface(s) 610 during execution thereof by the UE 302. The memory 602 and the processor(s) 608 also can constitute machine readable media 618.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein. For instance, techniques described in FIGS. 5 and 6 can be combined in various ways.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, by an edge computing device associated with an access network of a telecommunications system, a first message from a user equipment (UE) requesting a communication session;
determining, by the edge computing device and based at least in part on the first message, that the UE is associated with an unauthorized status for sending the first message over a core network of the telecommunications system;
determining, by the edge computing device and based at least in part on the unauthorized status associated with the UE, at least one of: a first communication channel for sending over the core network to a public service answering point (PSAP) or a second communication channel for sending over the access network and independent of the core network; and
transmitting, by the edge computing device, a second message to the UE indicating one of: the first communication channel or the second communication channel.

2. The method of claim 1, further comprising:
determining metadata associated with the UE based at least in part on one of: message data associated with the first message or historical data, the metadata describing one of: previous activity associated with the UE or predicted activity associated with the UE;
determining presentation data for output by the UE to enable the UE to exchange data over the core network; and
including the presentation data in the second message transmitted to the UE.

3. The method of claim 1, wherein:
the edge computing device represents a base station or hardware coupled to the UE, and
determining that the UE is associated with the unauthorized status is based at least in part on determining that the UE is not associated with a Mobile Network Operator.

4. The method of claim 1, further comprising:
determining, by the edge computing device, that the first message is associated with an emergency event, and
transmitting, based at least in part on determining that the first message is associated with the emergency event, the second message to include the first communication channel over the core network to the PSAP and the second communication channel.

5. The method of claim 1, further comprising:
transmitting the second message over the access network independent of the edge computing device sending a request for data to an Access and Mobility Management Function (AMF) or an IP Multimedia Subsystem (IMS) of the telecommunications system at a prior time;
wherein the second communication channel indicates one or more services available to the UE over the core network.

6. The method of claim 1, wherein:
the unauthorized status indicates that the UE is not authorized to access a base station, an Access and Mobility Management Function (AMF), or an IP Multimedia Subsystem (IMS) of the telecommunications system, and
transmitting the second message is further based at least in part on the UE not being authorized to access a network entity downstream from the edge computing device, the network entity comprising one of: the base station, the AMF, or the IMS.

7. A system comprising:
one or more processors; and
memory storing computer-executable instructions that, when executed by the one or more processors, cause the system to perform operations comprising:
receiving, by an edge computing device associated with an access network of a telecommunications system, a first message from a user equipment (UE) requesting a communication session;
determining, by the edge computing device and based at least in part on the first message, that the UE is associated with an unauthorized status for sending the first message over a core network of the telecommunications system;
determining, by the edge computing device and based at least in part on the unauthorized status associated with the UE, at least one of: a first communication channel for sending over the core network to a public service answering point (PSAP) or a second communication channel for sending over the access network and independent of the core network; and
transmitting, by the edge computing device, a second message to the UE indicating one of: the first communication channel or the second communication channel.

8. The system of claim 7, the operations further comprising:
determining metadata associated with the UE based at least in part on one of: message data associated with the first message or historical data, the metadata describing one of: previous activity associated with the UE or predicted activity associated with the UE;
determining presentation data for output by the UE to enable the UE to exchange data over the core network; and
including the presentation data in the second message transmitted to the UE.

9. The system of claim 7, wherein:
the edge computing device represents a base station or hardware coupled to the UE, and
determining that the UE is associated with the unauthorized status is based at least in part on determining that the UE is not associated with a Mobile Network Operator.

10. The system of claim 7, the operations further comprising:
determining, by the edge computing device, that the first message is associated with an emergency event, and
transmitting, based at least in part on determining that the message is associated with the emergency event, the second message to include the first communication channel over the core network to the PSAP and the second communication channel.

11. The system of claim 7, the operations further comprising:
transmitting the second message over the access network independent of the edge computing device sending a request for data to an Access and Mobility Management Function (AMF) or an IP Multimedia Subsystem (IMS) of the telecommunications system at a prior time;
wherein the second communication channel indicates one or more services available to the UE over the core network.

12. The system of claim 7, wherein:
the unauthorized status indicates that the UE is not authorized to access a base station, an Access and Mobility Management Function (AMF), or an IP Multimedia Subsystem (IMS) of the telecommunications system, and
transmitting the second message is further based at least in part on the UE not being authorized to access a network entity downstream from the edge computing device, the network entity comprising one of: the base station, the AMF, or the IMS.

13. The system of claim 7, wherein:
determining the first communication channel for sending over the core network to the PSAP is based at least in part on extracting emergency information from the first message, and
determining the second communication channel for sending over the access network is based at least in part on determining that an identifier of the UE is not associated with a service for exchange data over the core network.

14. The system of claim 7, the operations further comprising:
causing the UE to exchange data to over the access network instead of the core network.

15. The system of claim 7, the operations further comprising:
determining that the UE is associated with malicious activity over the access network; and
removing the UE from the access network based at least in part on determining that the UE is associated with the malicious activity.

16. One or more non-transitory computer-readable media storing instructions executable by one or more processors, wherein the instructions, when executed, cause the one or more processors to perform operations comprising:
receiving, by an edge computing device associated with an access network of a telecommunications system, a first message from a user equipment (UE) requesting a communication session, the UE being associated with an unauthorized status for sending the first message over a core network of the telecommunications system;
determining, by the edge computing device and based at least in part on the unauthorized status associated with the UE, at least one of: a first communication channel for sending over the core network to a public service answering point (PSAP) or a second communication channel for sending over the access network and independent of the core network; and
transmitting, by the edge computing device, a second message to the UE indicating one of: the first communication channel or the second communication channel.

17. The one or more non-transitory computer-readable media of claim 16, the operations further comprising:
determining, by the edge computing device and based at least in part on the first message, that the UE is associated with an unauthorized status for sending the first message over a core network of the telecommunications system.

18. The one or more non-transitory computer-readable media of claim 16, the operations further comprising:
determining, by the edge computing device, that the first message is associated with an emergency event, and
transmitting, based at least in part on determining that the first message is associated with the emergency event, the second message to include the first communication channel over the core network to the PSAP and the second communication channel.

19. The one or more non-transitory computer-readable media of claim 16, the operations further comprising:
transmitting the second message over the access network independent of the edge computing device sending a request for data to an Access and Mobility Management Function (AMF) or an IP Multimedia Subsystem (IMS) of the telecommunications system at a prior time;
wherein the second communication channel indicates one or more services available to the UE over the core network.

20. The one or more non-transitory computer-readable media of claim 16, the operations further comprising:
determining that the UE is associated with malicious activity over the access network; and
removing the UE from the access network based at least in part on determining that the UE is associated with the malicious activity.
